(19) United States
(12) Patent Application Publication
(10) Pub. No.: US 2008/0190822 A1
(43) Pub. Date: Aug. 14, 2008

(54) Screen for a Vibratory Separator Having Tension Reduction Feature

(75) Inventor: Charles A. Young, York, PA (US)

Correspondence Address: BARLEY SNYDER, PO BOX 1559, LANCASTER, PA, 17608-1559, US

(73) Assignee: Lumsden Corporation, Lancaster, PA (US)

(21) Appl. No.: 11/673,049

(22) Filed: Feb. 9, 2007

(51) Int. Cl. B07B 1/46

(52) U.S. Cl. 209/401

(57) ABSTRACT

A screen for a vibratory separator includes holding members and a woven wire cloth. The woven wire cloth has a plurality of warp wires extending between the holding members. The warp wires define openings in the woven wire cloth for the passage of material there through. The warp wires are arranged in pairs consisting of a first warp wire and a second warp wire. The warp wires are fixed to the holding members such that the first warp wire in each of the pairs has a greater tension applied thereto than the second warp wire in each of the pairs.

### FIELD OF THE INVENTION

The invention relates to a screen for a vibratory separator comprising a woven wire cloth having a plurality of warp wires extending between holding members wherein the warp wires are arranged in pairs and the warp wires are fixed to the holding member such that one of the warp wires in each of the pairs has a greater tension applied thereto than the other warp wire in each of the pairs.

### BACKGROUND

Screens mounted on vibratory separators are typically used by quarries to separate loose or suspended materials by grade and/or size. The screen typically consists of a woven wire cloth having a plurality of wires arranged and configured to form a plurality of openings therein. As the screen is vibrated, the material having a smaller size than the openings in the woven wire cloth is passed through the openings in the woven wire cloth, and the material having a larger size than the openings in the woven wire cloth are vibrated over and off of a top surface of the woven wire cloth onto a pile.

In the above described screen, problems occur in that the openings in the woven wire cloth can become blocked, which impedes the flow of the material through the openings. For example, if the material has a high moisture content, the material may adhere to the wires adjacent the openings thereby blocking the openings in the woven wire cloth. This phenomenon is typically referred to as “blinding.” Additionally, if the material has a substantially triangular or arrowhead shape, the material may become lodged in the openings thereby blocking the openings in the woven wire cloth. This phenomenon is typically referred to as “plugging.”

It is therefore desirable to provide a screen for a vibratory separator wherein blinding and plugging is prevented so that the volume of flow of the material through the openings in the woven wire cloth is not impeded.

### BRIEF SUMMARY

A screen for a vibratory separator comprises holding members and a woven wire cloth. The woven wire cloth has a plurality of warp wires extending between the holding members. The warp wires define openings in the woven wire cloth for the passage of material there through. The warp wires are arranged in pairs consisting of a first warp wire and a second warp wire. The warp wires are fixed to the holding members such that the first warp wire in each of the pairs has a greater tension applied thereto than the second warp wire in each of the pairs.

### BRIEF DESCRIPTION OF THE DRAWINGS

FIG. 1 is a perspective view of a screen for a vibratory separator according to a first embodiment of the invention.

FIG. 2 is a perspective view of a woven wire cloth of the screen of FIG. 1.

FIG. 3 is a perspective view of a first variation of the woven wire cloth for the screen of FIG. 1.

FIG. 4 is a perspective view of a second variation of the woven wire cloth for the screen of FIG. 1.

FIG. 5 is a perspective view of an alternate embodiment of a woven wire cloth for the screen of FIG. 1.

FIG. 6 is a perspective view of a screen for a vibratory separator according to a second embodiment of the invention.

FIG. 7 is a perspective view of a woven wire cloth of the screen of FIG. 6.

FIG. 8 is a sectional view along line 6-6 of FIG. 6.

### DETAILED DESCRIPTION OF THE EMBODIMENTS

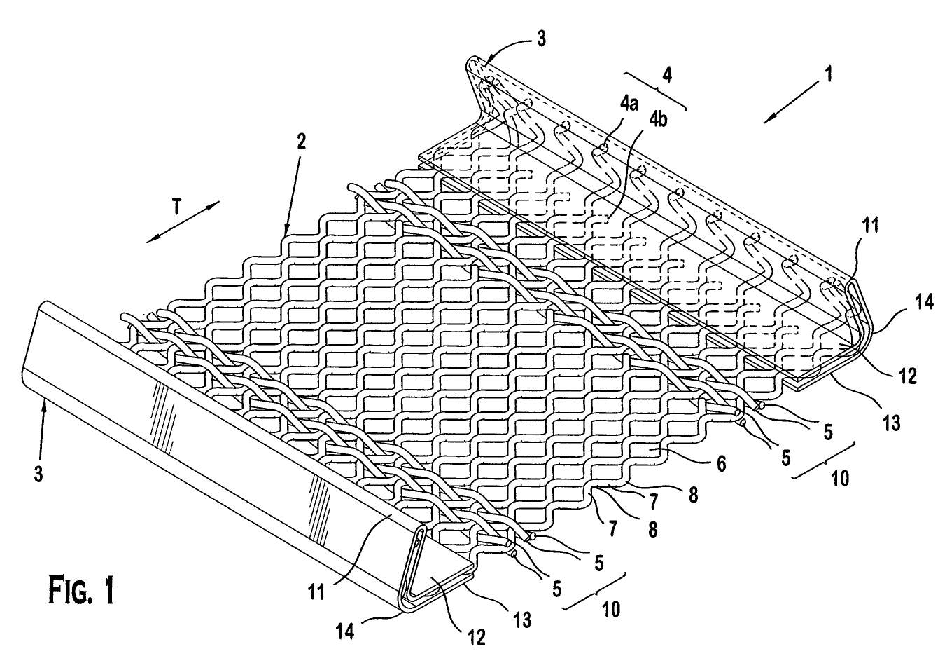

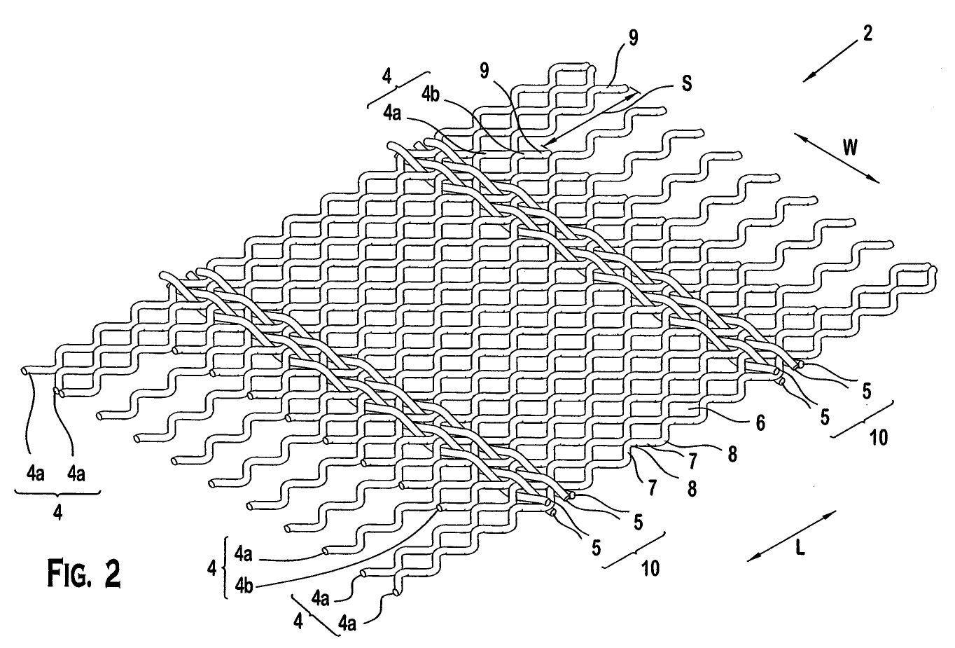

FIGS. 1-2 show a screen 1 for a vibratory separator according to a first embodiment of the invention. As shown in FIG. 1, the screen 1 comprises a woven wire cloth 2 that extends between a pair of holding members 3. As shown in FIG. 2, the woven wire cloth 2 includes a plurality of warp wires 4 and a plurality of fill or weft wires 5. The warp wires 4 are disposed substantially in a common plane and are arranged substantially parallel to each other. Each of the warp wires 4 has a substantially wave shape formed by a succession of substantially straight portions 7 connected together by oppositely bent portions 8. Each of the warp wires 4 has substantially the same diameter. Although the warp wires 4 are shown as round wires in the illustrated embodiment, the warp wires 4 may also be shaped wires.

As shown in FIG. 2, the warp wires 4 are arranged in pairs. The pairs of warp wires 4 arranged at a perimeter of the woven wire cloth 2 consist of first warp wires 4a. The remaining pairs of warp wires 4 consist of the first warp wire 4a and a second warp wire 4b. The first and second warp wires 4a, 4b are arranged such that the first and second warp wires 4a, 4b alternate with respect to a direction of width W of the woven wire cloth 2. The first warp wires 4a are longer than the second warp wires 4b with respect to a direction of length L of the woven wire cloth 2. The first and second warp wires 4a, 4b are arranged with respect to each other such that ends 9 of the second warp wire 4b are positioned a spaced distance S from the ends 9 of the first warp wires 4a. The pairs of first warp wires 4a and the pairs of first and second warp wires 4a, 4b are arranged with respect to each other such that the bent portions 8 of the warp wires 4 substantially oppose each other thereby forming openings 6 having a substantially diamond shaped configuration there between. It will be appreciated by those skilled in the art that the pairs of warp wires 4 arranged at the perimeter of the woven wire cloth 2 may alternatively consist of the first warp wire 4a and the second warp wire 4b.

As shown in FIG. 2, the weft wires 5 are disposed substantially in a common plane and are arranged substantially parallel to each other. The weft wires 5 have substantially the same diameter as the warp wires 4. Although the weft wires 5 are shown as round wires in the illustrated embodiment, the weft wires 5 may also be shaped wires. The weft wires 5 extend substantially perpendicular to the warp wires 4 in the direction of width W of the woven wire cloth 2. The weft wires 5 are woven through the warp wires 4 in groups 10 that are arranged at spaced intervals. The number of the groups 10 of the wefts wires 5 and the number of weft wires 5 in each of the groups 10 may vary depending on the length L of the woven wire cloth 2. The weft wires 5 may be woven through the warp wires 4, for example, by a double or triple heddle loom. The weft wires 5 maintain the warp wires 4 in spaced relation to each other. Alternatively or in addition to the weft wires 5, the warp wires 4 may be maintained in spaced relation to each other by molding the warp wires 4 together at spaced intervals. The warp wires 4 may be molded together, for example, with a polyurethane or rubber material.

As shown in FIG. 1, the holding members 3 are arranged on the ends 9 of the warp wires 4. The holding members 3 are substantially flat plates that may be formed, for example, from steel or other ferrous or non-ferrous materials. In an initial position (not shown), the substantially flat plates are bent by about 180 degrees at a first bent surface 11 to form an upper support surface 12 and a lower support surface 13. The ends 9 of the warp wires 4 are inserted between the upper support surface 12 and the lower support surface 13 until the first warp wires 4a either abut or substantially abut the first bent surface 11. In the initial position (not shown), the second warp wires 4b are positioned substantially the spaced distance S from the ends 9 of the first warp wires 4a and the first bent surface 11.

The holding members 3 are then pressed or crimped onto the ends 9 of the warp wires 4 by bending the holding members 3 at a second bent surface 14 toward the woven wire cloth 2 to form an angle at the second bent surface 14 substantially greater than 90 degrees. The second bent surface 14 is less than or equal to the spaced distance S from the first bent surface 11. The holding members 3 have a substantially C-shape configuration after pressing or crimping. Due to the pressing or crimping of the holding members 3, a tension T is applied across the first warp wires 4a of the woven wire cloth 2 in the direction of length L, and the first warp wires 4a are tightly secured between the upper and lower support members 12, 13. Because the second warp wires 4b are positioned substantially the spaced distance S from the ends 9 of the first warp wires 4a and the first bent surface 11, the second warped wires 4b are not bent at the second bent surface 14. The second warp wires 4b are therefore supported by the upper and lower support surfaces 12, 13, but are not tightly secured there between as a result of the pressing or crimping of the holding members 3. The second warp wires 4b are therefore subject to either no or less tension T than the first warp wires 4a.

Although the holding members 3 are shown and described herein as being made of a certain material and configuration, it will be appreciated by those skilled in the art that any holding member well known in the art that is configured to maintain the first warp wires 4a under tension T along the direction of length L of the woven wire cloth 2 may alternatively be used. Further, the first warp wires 4a may be secured in the holding members 3 by adding a bonding agent such as polyurethane, rubber, or other synthetic material. Additionally, it will be appreciated by those skilled in the art that only the ends 9 of the first warp wires 4a could be positioned inside the holding members 3.

When the screen 1 is mounted on a vibratory separator (not shown), the vibratory separator (not shown) imparts vibrations on the screen 1 so that a material (not shown) flowing through the screen 1 either flows through or is separated from the screen 1 by the openings 6. Because the second warp wires 4b are under less tension than the first warp wires 4a, the second warp wires 4b are able to vibrate at a higher frequency than the first warp wires 4a. The second warp wires 4b thereby prevent blinding and plugging so that the volume of flow of the material (not shown) through the openings 6 is not impeded.

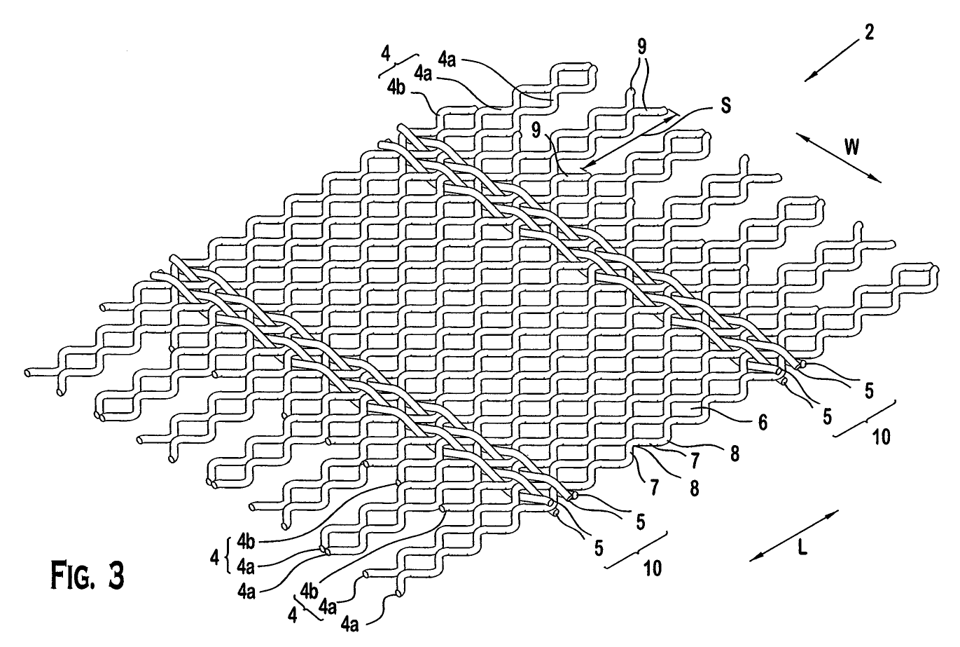

Although the woven wire cloth 2 is shown and described herein as having the warp wires 4 arranged in pairs consisting of the first warp wire 4a and the second warp wire 4b wherein the first and second warp wires 4a, 4b alternate with respect to the direction of width W of the woven wire cloth 2, it will be appreciated by those skilled in the art that the concepts shown and described herein may be applied to woven wire cloths having other warp wire configurations. For example, FIG. 3 shows an example of a first variation of the woven wire cloth 2. As shown in FIG. 3, the warp wires 4 are arranged such that each of the pairs consisting of the first warp wire 4a and the second warp wire 4b are separated by one of the first warp wires 4a. Because the assembly and method of use of the woven wires cloth 2 shown in FIG. 3 is the same as the assembly and method of use of the woven wire cloth 2 shown in FIG. 2, further description thereof will not be provided herein.

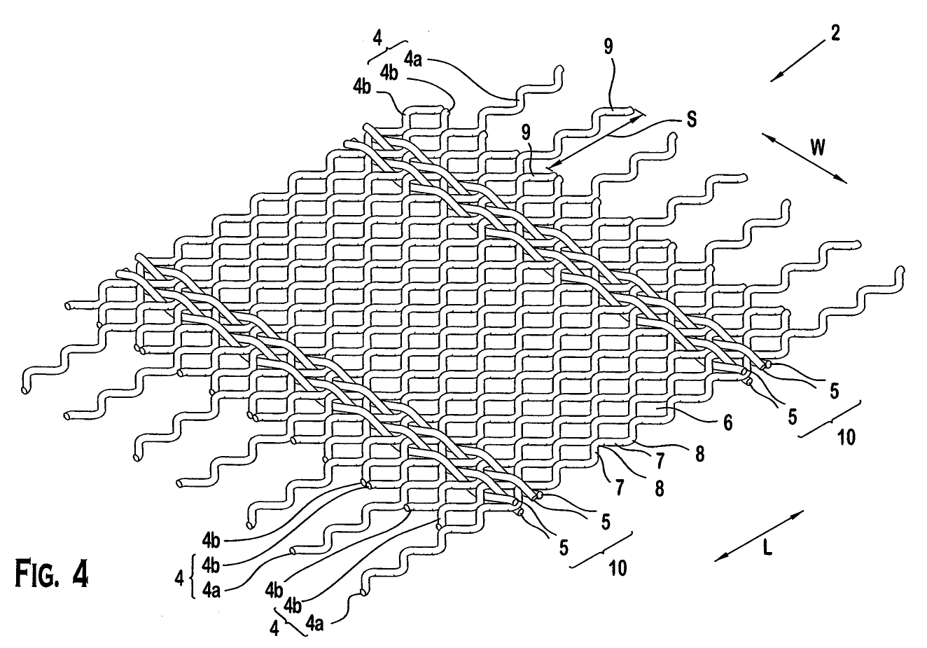

FIG. 4 shows an example of a second variation of the woven wire cloth 2. As shown in FIG. 4, the warp wires 4 are arranged such that each of the pairs consisting of the first warp wire 4a and the second warp wire 4b are separated by one of the second warp wires 4b. Because the assembly and method of use of the woven wires cloth 2 shown in FIG. 4 is the same as the assembly and method of use of the woven wire cloth 2 shown in FIG. 2, further description thereof will not be provided herein.

Additionally, although the woven wire cloth 2 is shown and described herein as having the warp wires 4 arranged and configured such that the openings 6 have a substantially diamond shape, it will be appreciated by those skilled in the art that the concepts shown and described herein may be applied to woven wire cloths having other configurations. For example, the warp wires 4 may be arranged and configured such that continuous openings having a substantially wave shaped configuration are formed. Additionally, the warp wires 4 may be arranged and configured such that the openings 6 have a substantially rectangular or triangular shaped configuration.

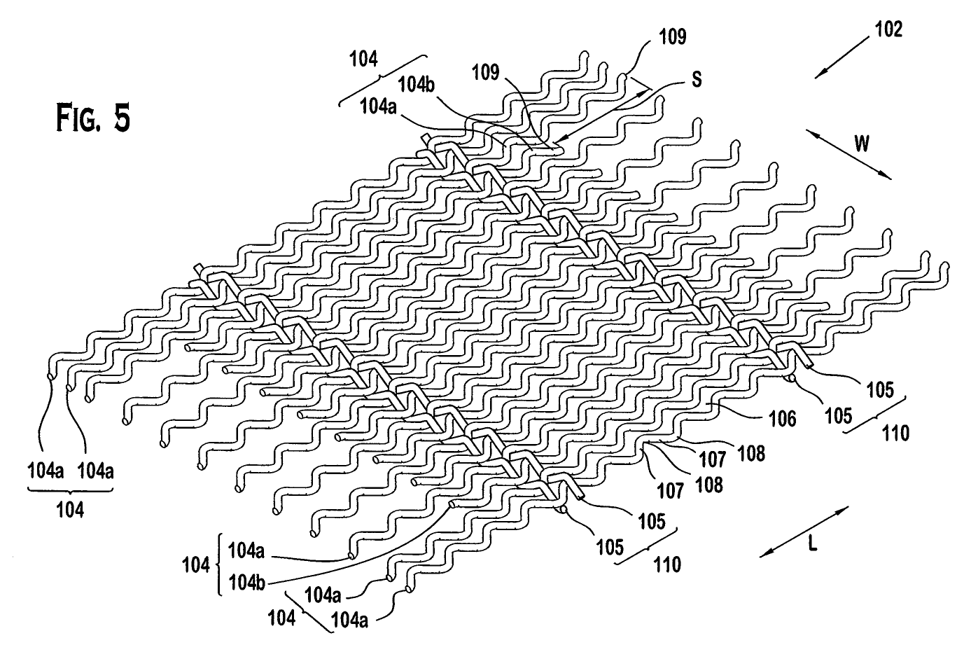

For example, FIG. 5 shows an example of an alternate embodiment of a woven wire cloth 102 with continuous openings 106 having a substantially wave shaped configuration. As shown in FIG. 3, the woven wire cloth 102 is identical to the woven wire cloth 2, except the warp wires 104 are arranged with respect to each other such that the bent portions 108 of the warp wires 104 substantially oppose each other to form the continuous openings 106 having a substantially wave shaped configuration. Each of the openings 106 extends between the ends 109 of the warp wires 104 in the direction of length L of the woven wire cloth 102. Because the assembly and method of use of the woven wires cloth 102 is the same as the assembly and method of use of the woven wire cloth 2, further description thereof will not be provided herein.

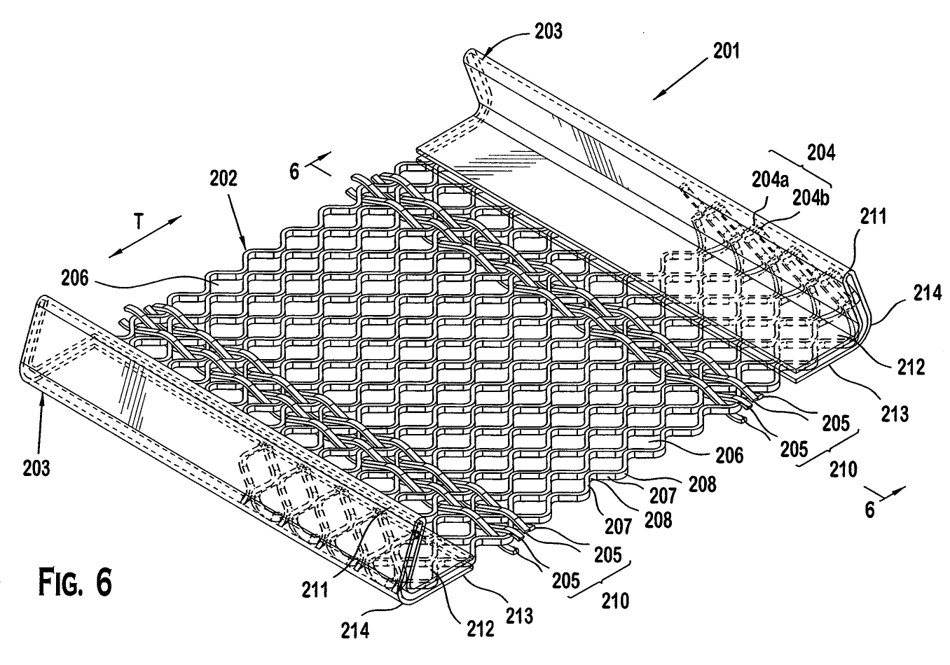

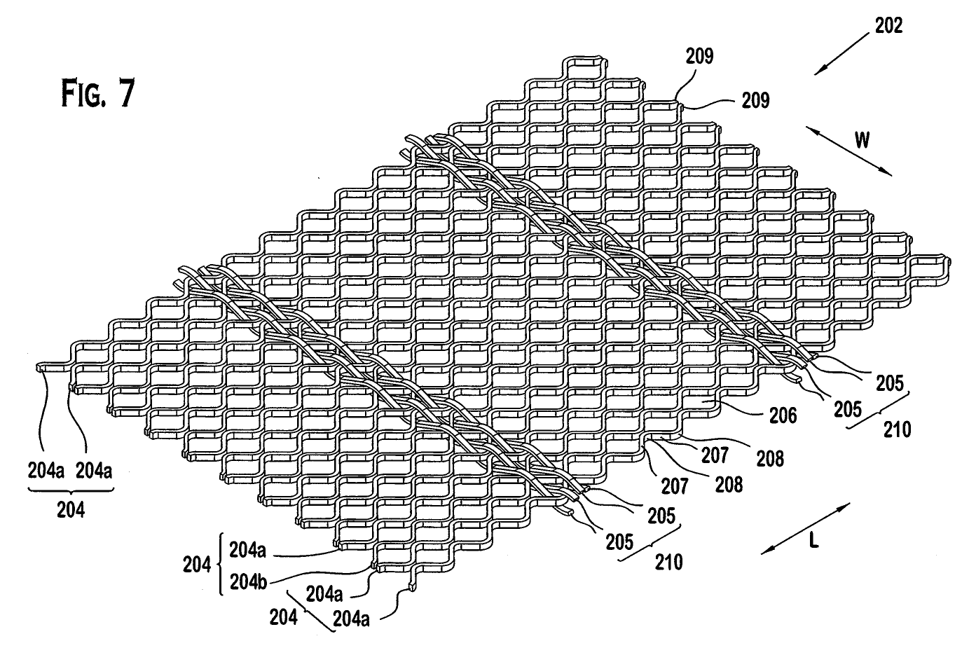

FIGS. 6-8 show a screen 201 for a vibratory separator according to a second embodiment of the invention. As shown in FIG. 6, the screen 201 comprises a woven wire cloth 202 that extends between a pair of holding members 203. As shown in FIG. 7, the woven wire cloth 202 includes a plurality of warp wires 204 and a plurality of fill or weft wires 205. The warp wires 204 are disposed substantially in a common plane and are arranged substantially parallel to each other. The warp wires 204 are substantially the same length with respect to a direction of length L of the woven wire cloth 202. Each of the warp wires 204 has a substantially wave shape formed by a succession of substantially straight portions 207 connected together by oppositely bent portions 208. Although the warp wires 204 are shown as shaped wires in the illustrated embodiment, the warp wires 204 may also be round wires.

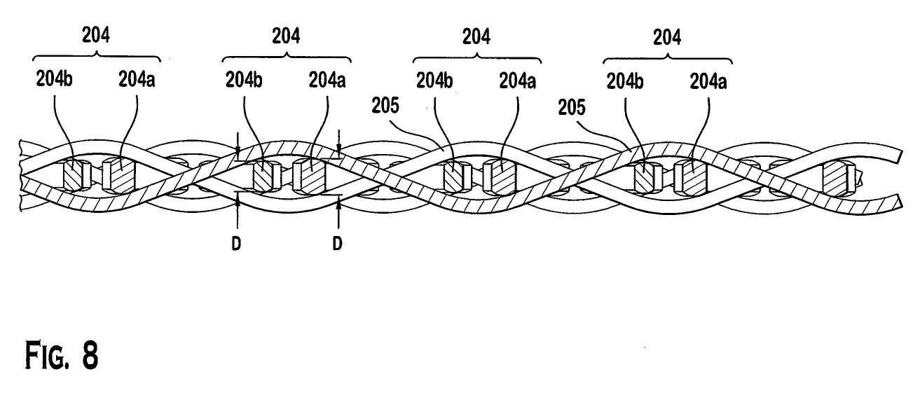

As shown in FIG. 7, the warp wires 204 are arranged in pairs. The pairs of warp wires 204 arranged at a perimeter of the woven wire cloth 202 consist of first warp wires 202a. The remaining pairs of warp wires 204 consist of the first warp wire 204a and a second warp wire 204b. The first and second warp wires 204a, 204b are arranged such that the first and second warp wires 204a, 204b alternate with respect to a direction of width W of the woven wire cloth 202. As shown in FIG. 8, the first warp wires 204a have a larger diameter D than the second warp wires 204b. The pairs of first warp wires 204a and the pairs of first and second warp wires 204a, 204b are arranged with respect to each other such that the bent portions 208 of the warp wires 204 substantially oppose each other thereby forming openings 206 having a substantially diamond shaped configuration there between, as shown in FIG. 7. It will be appreciated by those skilled in the art that the pairs of warp wires 204 arranged at the perimeter of the woven wire cloth 202 may alternatively consist of the first warp wire 204a and the second warp wire 204b.

As shown in FIG. 7, the weft wires 205 are disposed substantially in a common plane and are arranged substantially parallel to each other. The weft wires 205 have substantially the same diameter as the warp wires 204. Although the weft wires 205 are shown as shaped wires in the illustrated embodiment, the weft wires 5 may also be round wires. The weft wires 205 extend substantially perpendicular to the warp wires 204 in the direction of width W of the woven wire cloth 202. The weft wires 205 are woven through the warp wires 204 in groups 210 that are arranged at spaced intervals. The number of the groups 210 of the wefts wires 205 and the number of weft wires 205 in each of the groups 210 may vary depending on the length L of the woven wire cloth 202. The weft wires 205 may be woven through the warp wires 204, for example, by a double or triple heddle loom. The weft wires 205 maintain the warp wires 204 in spaced relation to each other. Alternatively or in addition to the weft wires 205, the warp wires 204 may be maintained in spaced relation to each other by molding the warp wires 204 together at spaced intervals. The warp wires 204 may be molded together, for example, with a polyurethane or rubber material.

As shown in FIG. 6, the holding members 203 are arranged on ends 209 of the warp wires 204. The holding members 203 are substantially flat plates that may be formed, for example, from steel, or other ferrous or non-ferrous materials. In an initial position (not shown), the substantially flat plates are bent by about 180 degrees at a first bent surface 211 to form an upper support surface 212 and a lower support surface 213. The ends 209 of the warp wires 204 are inserted between the upper support surface 212 and the lower support surface 213 until the warp wires 204 either abut or substantially abut the first bent surface 211.

The holding members 203 are then pressed or crimped onto the ends 209 of the warp wires 204 by bending the holding members 203 at a second bent surface 214 toward the woven wire cloth 202 to form an angle at the second bent surface 214 substantially greater than 90 degrees. The holding members 203 have a substantially C-shape configuration after pressing or crimping. Due to the pressing or crimping of the holding members 203, a tension T is applied across the warp wires 204 of the woven wire cloth 202 in the direction of length L, and the warp wires 204 are secured between the upper and lower support members 212, 213. Because the second warp wires 204b have a smaller diameter D than the first warp wires 2a, the second warp wires 204b are subject to less tension T than the first warp wires 204a.

Although the holding members 203 are shown and described herein as being made of a certain material and configuration, it will be appreciated by those skilled in the art that any holding member well known in the art that is configured to maintain the warp wires 204 under tension T along the direction of length L of the woven wire cloth 202 may alternatively be used. Further, the first warp wires 4a may be secured in the holding members 3 by adding a bonding agent such as polyurethane, rubber, or other synthetic material.

When the screen 201 is mounted on a vibratory separator (not shown), the vibratory separator (not shown) imparts vibrations on the screen 201 so that a material (not shown) flowing through the screen 201 either flows through or is separated from the screen 201 by the openings 206. Because the second warp wires 204b are under less tension than the first warp wires 204a, the second warp wires 204b are able to vibrate at a higher frequency than the first warp wires 204a. The second warp wires 204b thereby prevent blinding and plugging so that the volume of flow of the material (not shown) through the openings 206 is not impeded.

Although the woven wire cloth 202 is shown and described herein as having the warp wires 204 arranged and configured such that the openings 206 have a substantially diamond shape, it will be appreciated by those skilled in the art that the concepts shown and described herein may be applied to woven wire cloths having other configurations. For example, the warp wires 204 may be arranged and configured such that continuous openings having a substantially wave shaped configuration are formed, or the warp wires 204 may be arranged and configured such that the openings 206 have a substantially rectangular or triangular shaped configuration. Additionally, although the woven wire cloth 202 is shown and described herein as having the warp wires 4 arranged in pairs consisting of the first warp wire 204a and the second warp wire 204b wherein the first and second warp wires 204a, 204b alternate with respect to the direction of width W of the woven wire cloth 202, it will be appreciated by those skilled in the art that the concepts shown and described herein may be applied to woven wire cloths having other warp wire configurations. For example, each of the pairs consisting of the first warp wire 204a and the second warp wire 204b may be separated by one of the first warp wires 204a or one of the second warp wires 204b.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

What is claimed is:

1. A screen for a vibratory separator, comprising:
holding members; and
a woven wire cloth having a plurality of warp wires extending between the holding members, the warp wires defining openings in the woven wire cloth for the passage of material there through, the warp wires being arranged in pairs consisting of a first warp wire and a second warp wire, the warp wires being fixed to the holding members such that the first warp wire in each of the pairs has a greater tension applied thereto than the second warp wire in each of the pairs.

2. The screen of claim 1, wherein the first and second warp wires alternate along a direction of width of the woven wire screen.

3. The screen of claim 1, wherein the second warp wires vibrates at a higher frequency than the first warp wires.

4. The screen of claim 1, wherein the openings have a substantially diamond shaped configuration.

5. The screen of claim 1, wherein the openings have a substantially wave shaped configuration.

6. The screen of claim 1, wherein the first warp wires are longer than the second warp wires with respect to a direction of length of the woven wire cloth.

7. The screen of claim 6, wherein each of the pairs is separated by one of the first warp wires or one of the second warp wires.

8. The screen of claim 1, wherein the first warp wires have a diameter greater than the second warp wires.

9. The screen of claim 1, wherein each of the warp wires have a succession of substantially straight portions connected together by oppositely bent portions.

10. The screen of claim 1, wherein the holding members are pressed or crimped onto ends of the warp wires.

11. The screen of claim 1, wherein the holding members have a substantially C-shaped configuration.

12. The screen of claim 1, wherein the warp wires are round wires or shaped wires.

13. The screen of claim 1, wherein the first and second warp wires have the same diameter.

14. The screen of claim 1, further comprising weft wires extending substantially perpendicular to the warp wires, the weft wires being woven through the warp wires in groups at spaced intervals.

15. The screen of claim 14, wherein the weft wires and the first and second warp wires have the same diameter.
